(19) United States
(12) Patent Application Publication
(10) Pub. No.: US 2023/0187736 A1
(43) Pub. Date: Jun. 15, 2023

(54) METAL-AIR BATTERY MODULE

(71) Applicant: SHARP KABUSHIKI KAISHA, Sakai City (JP)

(72) Inventors: HIROYUKI HIRAKAWA, Sakai City (JP); HIROTAKA MIZUHATA, Sakai City (JP); SHUNSUKE SATA, Sakai City (JP)

(21) Appl. No.: 18/078,046

(22) Filed: Dec. 8, 2022

(30) Foreign Application Priority Data
Dec. 15, 2021 (JP) 2021-203259

(51) Int. Cl. H01M 12/08; H01M 50/264; H01M 50/211; H01M 50/105; H01M 50/131

(52) U.S. Cl. CPC H01M 12/08; H01M 50/264; H01M 50/211; H01M 50/105; H01M 50/131

(57) ABSTRACT

This metal-air battery module includes a metal-air battery cell, a plate member, and a pair of fixing members. The metal-air battery cell has a resin film provided with an opening, and a water-repellent film which is arranged and welded so as to cover the opening. The plate member is arranged facing the surface of the metal-air battery cell that is provided with the opening. The metal-air battery cell and the plate member are fixed by the pair of fixing members at a surface end in a surface direction, which is a direction along a surface in which both components face each other, the pair of fixing members being opposingly arranged so as to sandwich both components in the surface direction.

### BACKGROUND OF THE INVENTION

### Field of the Invention

The present disclosure relates to a metal-air battery module provided with a metal-air battery cell, a plate member, and a pair of fixing members.

### Description of the Background Art

In recent years, a variety of batteries using a chemical reaction of a metal for an electrode have been practically used. One example of such a battery is a metal-air battery. A metal-air battery is provided with an air electrode (positive electrode) and a fuel electrode (negative electrode), and is used by extracting and using the electrical energy obtained through an electrochemical reaction process in which a metal such as zinc, iron, magnesium, aluminum, sodium, calcium, or lithium is converted into a metal oxide. When being charged and discharged, the metal-air battery must be cooled because the reaction mentioned above generates heat. Therefore, a method of improving the cooling performance of a metal-air battery has been proposed.

The fluid-cooled battery pack system described in the proposed method includes a battery pack case having a coolant inlet and a coolant outlet, a battery pack arranged inside the battery pack case, and a coolant transfer device that causes a coolant to be taken in from the coolant inlet and discharged from the coolant outlet via a coolant flow path. The battery pack is configured by a plurality of battery modules that are connected together, and the coolant flow path between the battery modules is set to a target width.

In metal-air batteries, battery operation can sometimes cause expansion deformation to occur in addition to heat generation. Therefore, in the fluid-cooled battery pack system described above, expansion deformation may cause the coolant flow path to become narrow, resulting in a deterioration in battery performance.

The present disclosure has been made to solve the problems described above. An object of the present disclosure is to provide a metal-air battery module that is capable of suppressing the deformation of a metal-air battery, while also ensuring an air supply.

### SUMMARY OF THE INVENTION

A metal-air battery module according to the present disclosure includes: a metal-air battery cell; a plate member; and a pair of fixing members; wherein the metal-air battery cell has a film-like packaging material provided with an opening, and a water-repellent film which is arranged and welded so as to cover the opening, the plate member is arranged facing a surface of the metal-air battery cell, the surface being provided with the opening, and the metal-air battery cell and the plate member are fixed by the pair of fixing members at a surface end in a surface direction, which is a direction along a surface in which both components face each other, the pair of fixing members being opposingly arranged so as to sandwich both components in the surface direction.

The metal-air battery module according to the present disclosure may be configured such that the plate member is provided with a contacter that makes contact with the metal-air battery cell, and the contacter is provided with a first contact region, and a second contact region having a higher contact density than the first contact region.

The metal-air battery module according to the present disclosure may be configured such that the metal-air battery cell is provided with a water-repellent film welded part along a circumferential edge of the opening, on which the water-repellent film is welded, the first contact region is provided in a position facing the opening, and the second contact region is provided in a position facing the water-repellent film welded part.

The metal-air battery module according to the present disclosure may be configured such that a portion of the pair of fixing members are provided in a position facing the water-repellent film welded part.

The metal-air battery module according to the present disclosure may be configured such that the contacter is formed in a corrugated plate shape.

The metal-air battery module according to the present disclosure may be configured such that a channel provided in the contacter is formed with an orientation parallel to a flow path of air.

The metal-air battery module according to the present disclosure may be configured such that the contacter is a cylindrical protrusion.

The metal-air battery module according to the present disclosure may be configured such that the contacter is a spindle-shaped protrusion.

The metal-air battery module according to the present disclosure may be configured such that the pair of fixing members hold ends of the plate member, and fix positions thereof.

The metal-air battery module according to the present disclosure may be configured such that the plate member is provided with a through hole that penetrates therethrough.

According to the present disclosure, by fixing the metal-air battery cell and the plate member with the pair of fixing members, it is possible to suppress the deformation of the metal-air battery cell, while also ensuring an air supply.

### BRIEF DESCRIPTION OF THE DRAWINGS

FIG. 1 is a perspective view of a metal-air battery module according to a first embodiment of the present disclosure.

FIG. 2 is a front view of the metal-air battery module according to the first embodiment of the present disclosure.

FIG. 3 is a side view of the metal-air battery module according to the first embodiment of the present disclosure.

FIG. 4 is a front view of a metal-air battery cell.

FIG. 5 is a cross-sectional view of the metal-air battery cell shown in FIG. 4 taken along arrow A-A.

FIG. 6 is a front view of a metal-air battery cell.

FIG. 7 is a cross-sectional view of the metal-air battery cell shown in FIG. 6 taken along arrow B-B.

FIG. 8 is a perspective view of a fixing member.

FIG. 9 is a top view of a fixing member.

FIG. 10 is a perspective view of a plate member.

FIG. 11 is a front view of a plate member.

FIG. 12 is a perspective view of a metal-air battery module according to a second embodiment of the present disclosure.

FIG. 13 is a front view of the metal-air battery module according to the second embodiment of the present disclosure.

FIG. 14 is a side view of the metal-air battery module according to the second embodiment of the present disclosure.

FIG. 15 is a perspective view of a plate member.

FIG. 16 is a front view of a plate member.

FIG. 17 is a perspective view of a metal-air battery module according to a third embodiment of the present disclosure.

FIG. 18 is a front view of the metal-air battery module according to the third embodiment of the present disclosure.

FIG. 19 is a side view of the metal-air battery module according to the third embodiment of the present disclosure.

FIG. 20 is a perspective view of a plate member.

FIG. 21 is a front view of a plate member.

### DESCRIPTION OF THE PREFERRED EMBODIMENTS

### First Embodiment

A metal-air battery module according to a first embodiment of the present disclosure will be described below with reference to the drawings.

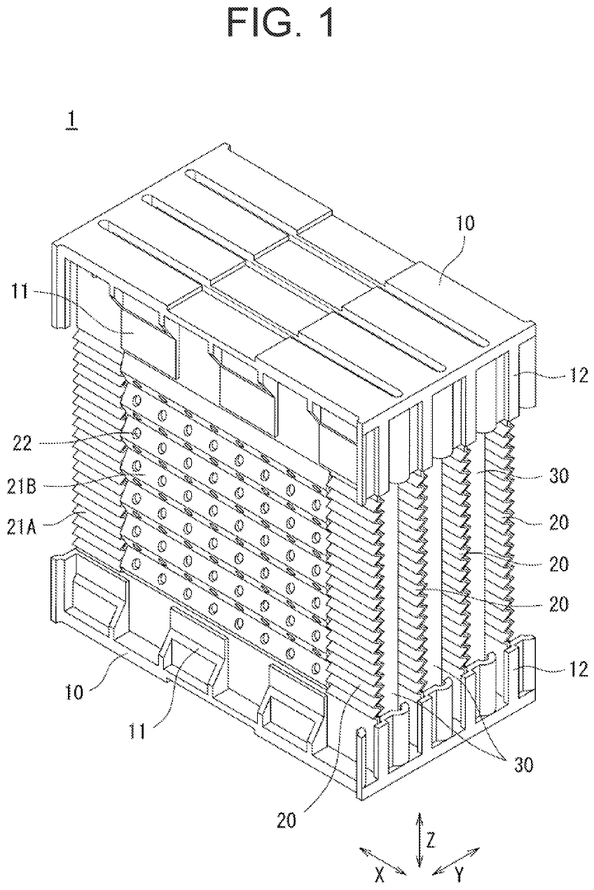

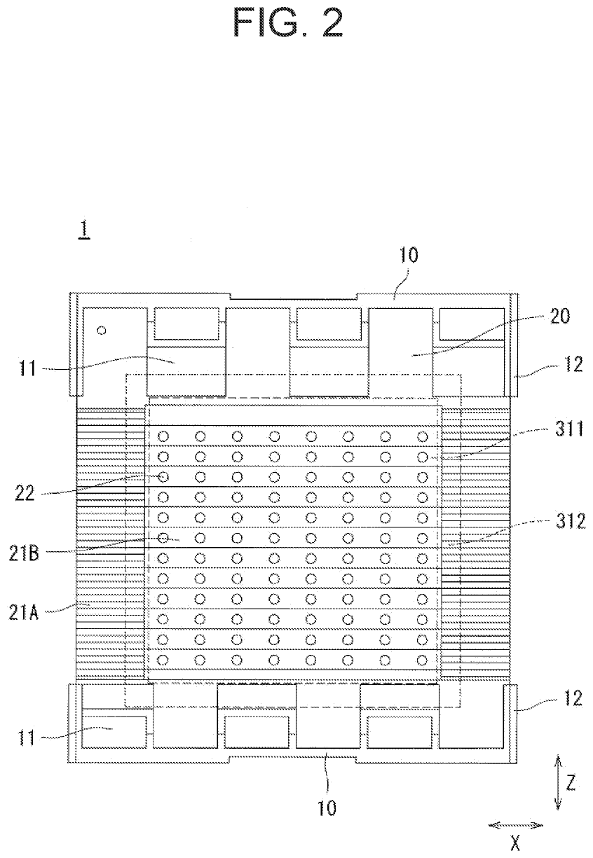

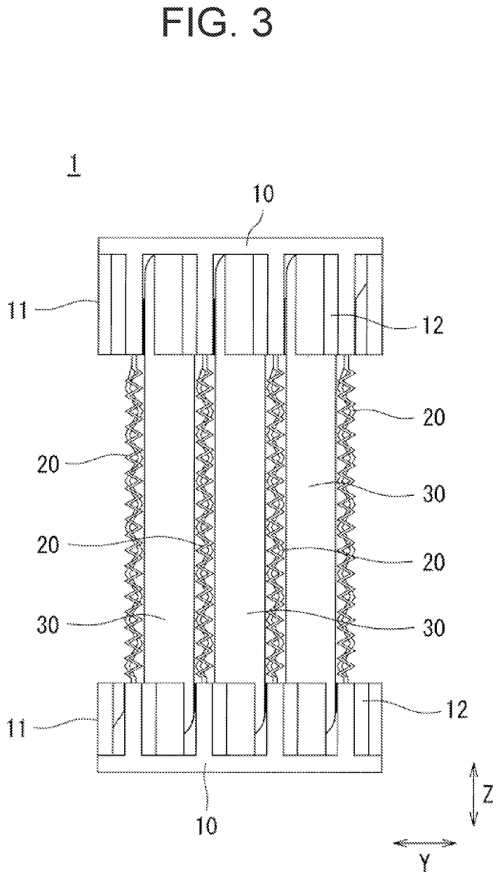

FIG. 1 is a perspective view of the metal-air battery module according to the first embodiment of the present disclosure. FIG. 2 is a front view of the metal-air battery module according to the first embodiment of the present disclosure. FIG. 3 is a side view of the metal-air battery module according to the first embodiment of the present disclosure. In FIG. 2, a portion of the metal-air battery cell 30 is shown transparently for ease of viewing of the diagram.

The metal-air battery module 1 according to the first embodiment of the present disclosure includes metal-air battery cells 30, plate members 20, and fixing members 10. In the metal-air battery module 1, the metal-air battery cells 30 and the plate members 20 are fixed by the fixing members 10 at surface ends in a surface direction, which is a direction along the surface in which both components face each other (a direction corresponding to the height direction Z described later), the fixing members 10 being opposingly arranged so as to sandwich both components in the surface direction. Specifically, a pair of fixing members 10 is opposingly arranged in the height direction Z of the metal-air battery module 1, and fixes the upper end and lower end of the metal-air battery cells 30 and the plate members 20. That is, the fixing members 10 hold the ends of the plate members 20, and fix the positions thereof In the present embodiment, three metal-air battery cells 30 and four plate members 20 are alternately arranged side-by-side in the thickness direction Y. The present disclosure is not limited to this, and the number of metal-air battery cells 30 and plate members 20 can be appropriately set, and the size of the fixing members 10 can be adjusted according to the number of metal-air battery cells 30 and plate members 20.

In the metal-air battery module 1, the side surfaces in the width direction X, which is orthogonal to the thickness direction Y, are open to allow air to be supplied to the metal-air battery cells 30 arranged on the inside. The present disclosure is not limited to this, and a housing that covers the surface of the metal-air battery module 1 may be provided. In this case, it is also possible to provide an opening in the side surface in the width direction X, such that air is taken into the interior.

Next, detailed structures of each of the metal-air battery cell 30, the plate member 20, and the fixing member 10 will be described with reference to the drawings.

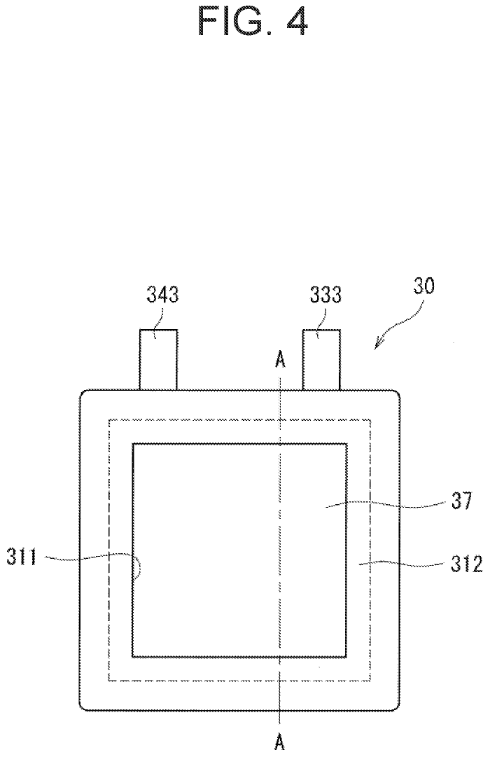

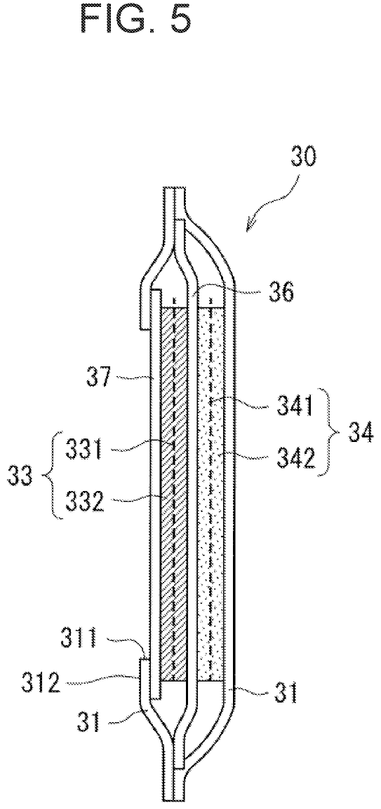

FIG. 4 is a front view of a metal-air battery cell. FIG. 5 is a cross-sectional view of the metal-air battery cell shown in FIG. 4 taken along arrow A-A.

FIG. 4 and FIG. 5 show the configuration of the metal-air battery cell 30 in the form of a primary battery. In the metal-air battery cell 30, two resin films 31 (an example of a packaging material) are pasted together to form a battery case (outer packaging member). The inside of the resin films 31 houses an air electrode 33, a negative electrode 34, and a separator 36, and is filled with an electrolyte (not shown). The resin film 31 on the side facing the air electrode 33 is provided with an opening 311 substantially in the center when viewed from the front, and a water-repellent film 37 is arranged so as to cover the opening 311. The resin film 31 is provided with a water-repellent film welded part 312 along the circumferential edge of the opening 311. Further, the outer periphery of the water-repellent film 37 is welded to the water-repellent film welded part 312. Note that an opening 311 is not provided in the resin film 31 on the side facing the negative electrode 34.

The inside of the resin films 31 has the air electrode 33 and the negative electrode 34 arranged side-by-side in this order along the thickness direction Y. That is, the air electrode 33 is arranged facing one of the resin films 31, and the negative electrode 34 is arranged facing the other resin film 31. The separator 36 is arranged between the air electrode 33 and the negative electrode 34. The circumferential edge of the separator 36 may be adhered together with the circumferential edges of the two resin films 31.

The air electrode 33 includes a current collector 331 and a catalyst layer 332 in contact with the current collector 331, and serves as a positive electrode having an oxygen reducing capability and an oxygen generating capability. A portion of the current collector 331 extends outside the packaging material, and serves as a lead 333 of the metal-air battery cell 30. The current collector 331 is not particularly limited as long as it is a material that is commonly used in the field of metal-air batteries, and the thickness is preferably 0.05 mm to 0.5 mm.

The catalyst layer 332 includes at least an air electrode catalyst. The air electrode catalyst is a catalyst having at least an oxygen reducing capability. Examples of the air electrode catalyst include conductive carbons such as ketjen black, acetylene black, denka black, carbon nanotubes, and fullerenes, metals, metal oxides, metal hydroxides, and metal sulfides, and these may be used singly or in combination of two or more.

A three-phase interface where oxygen gas, water, and electrons coexist can be formed on the air catalyst, which enables a discharge reaction to proceed. If the metal-air battery cell 30 is a primary battery, the catalyst layer 332 may contain a catalyst such as manganese dioxide. Furthermore, if the metal-air battery cell 30 is a secondary battery, the catalyst layer 332 may contain not only an air electrode catalyst having an oxygen reducing capability, but also a catalyst having an oxygen generating capability such that both an oxygen reducing capability and an oxygen generating capability are provided. The thickness of the catalyst layer 332 is preferably 0.1 mm or more and 1.0 mm or less.

The negative electrode 34 is formed by laminating an active material layer 342 on a current collector 341. Note that the present disclosure is not limited to this, and the current collector 341 and a negative electrode active material (such as zinc or zinc oxide) in a particle form may be separately added and laminated. Moreover, the negative electrode 34 may include the current collector 341 and a colloidal slurry in which particles of a negative electrode active material and an electrolyte are mixed. The slurry preferably has a ratio of the weight of the electrolyte to the weight of the negative electrode active material of 0.3 to 2.0.

The negative electrode active material is appropriately selected from materials commonly used in the field of metal-air batteries, and examples include a metallic species such as a cadmium species, a lithium species, a sodium species, a magnesium species, a lead species, a zinc species, a tin species, an aluminum species, and an iron species. Because the negative electrode active material is reduced by being charged, it may be in a metal oxide state. The average particle size of the negative electrode active material is 1 nm to 300 μm, preferably 100 nm to 250 μm, and particularly preferably 200 nm to 200 μm.

In the negative electrode 34, a portion of the current collector 341 similarly extends outside the packaging material, and serves as a lead 343 of the metal-air battery cell 30.

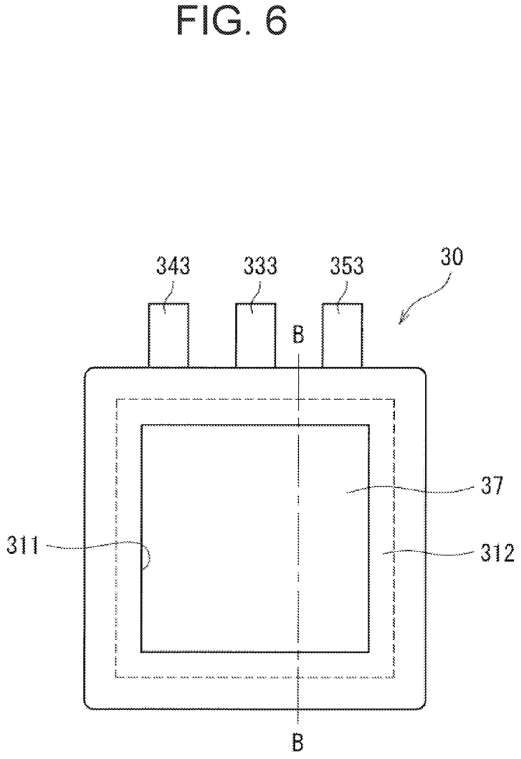

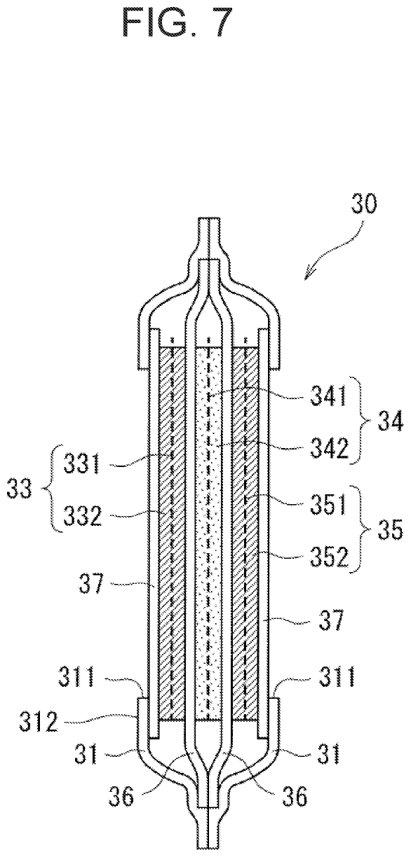

The metal-air battery cell 30 is not limited to the primary battery shown in FIG. 4 and FIG. 5, and the secondary battery shown in FIG. 6 and FIG. 7 may be used.

FIG. 6 is a front view of a metal-air battery cell. FIG. 7 is a cross-sectional view of the metal-air battery cell shown in FIG. 6 taken along arrow B-B.

FIG. 6 and FIG. 7 show the configuration of the metal-air battery cell 30 in the form of a secondary battery. In the metal-air battery cell 30, two resin films 31 (an example of a packaging material) are pasted together to form a battery case (outer packaging member). The inside of the resin films 31 houses an air electrode 33 (first positive electrode), a negative electrode 34, a charging electrode 35 (second positive electrode), and two separators 36, and is filled with an electrolyte (not shown). The resin film 31 is provided with an opening 311 substantially in the center when viewed from the front, and a water-repellent film 37 is arranged so as to cover the opening 311. The resin film 31 is provided with a water-repellent film welded part 312 along the circumferential edge of the opening 311. Further, the outer periphery of the water-repellent film 37 is welded to the water-repellent film welded part 312.

The inside of the resin films 31 has the air electrode 33, the negative electrode 34, and the charging electrode 35 arranged side-by-side in this order along the thickness direction Y. That is, the air electrode 33 is arranged facing one of the resin films 31, and the charging electrode 35 is arranged facing the other resin film 31. The separators 36 are respectively arranged between the air electrode 33 and the negative electrode 34, and between the negative electrode 34 and the charging electrode 35. The circumferential edges of the two separators 36 may be adhered together with the circumferential edges of the two resin films 31.

The air electrode 33 and the negative electrode 34 are configured in substantially the same manner as shown in FIG. 4 and FIG. 5. Further, a portion of the current collector 331 and the current collector 341 extend outside the packaging material, and serve as a lead 333 and a lead 343 of the metal-air battery cell 30.

The charging electrode 35 is configured by a current collector 351 and a catalyst layer 352. The catalyst layer 352 includes, for example, a conductive porous carrier and a charging electrode catalyst supported on the porous carrier. The charging electrode catalyst is a catalyst having an oxygen generating capability (such as nickel), and causes the charging reaction to proceed when the metal-air battery cell 30 is charged. For example, the catalyst layer 352 is formed of foamed nickel.

In the charging electrode 35, a portion of the current collector 351 similarly extends outside the packaging material, and serves as a lead 353 of the metal-air battery cell 30.

In the configuration shown in FIG. 6 and FIG. 7, the charging electrode 35 may be replaced by a second air electrode to form a primary battery. That is, in this configuration, air electrodes are arranged on both sides of the negative electrode 34. The same material as that of the other air electrode 33 may be used as the material of the second air electrode.

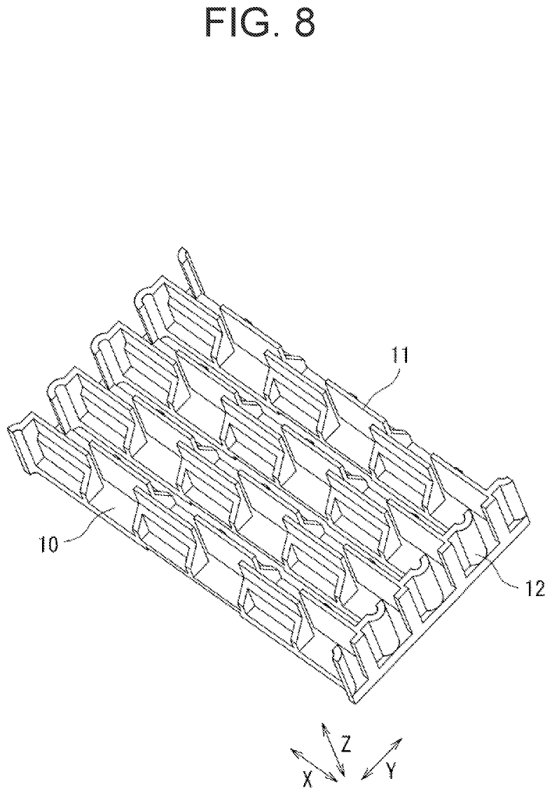

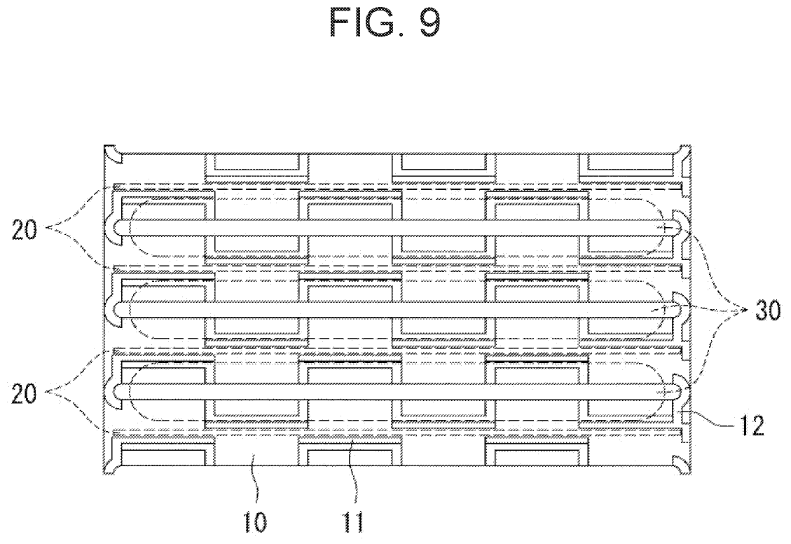

FIG. 8 is a perspective view of a fixing member. FIG. 9 is a top view of a fixing member. In FIG. 9, the metal-air battery cells 30 and the plate members 20 supported by the fixing member 10 are shown schematically. The plate members 20 are drawn showing only the end that is sandwiched by the claws 11 of the fixing member 10.

In FIG. 8 and FIG. 9, one of the pair of fixing members 10 is shown. The other fixing member 10 has substantially the same structure as the fixing member 10 shown in FIG. 8 and FIG. 9. Therefore, the illustration and description are omitted. The fixing member 10 has a base that is positioned below (or above) the metal-air battery cells 30 and the plate members 20, and claws 11 and side walls 12 that stand up from the base.

The claws 11 are formed long along the width direction X, and a plurality of claws 11 are provided with a spacing in the thickness direction Y. The metal-air battery cells 30 and the plate members 20 are alternately arranged between claws 11 that are separated from each other in the thickness direction Y. The spacing of the claws 11 in the thickness direction Y is appropriately set according to the thickness of the metal-air battery cells 30 and the plate members 20.

As shown in FIG. 2, the height of the claws 11 that stand up from the base is a level that narrowly prevents the end portion of the metal-air battery cell 30 from reaching the opening 311. Further, the claws 11 face the water-repellent film welded part 312. Therefore, the section of the metal-air battery cell 30 supported by the fixing member 10 can be reliably prevented from deformation at the water-repellent film welded part 312 due to the fixing member 10.

The side walls 12 are provided at both opposing end portions of the base in the width direction X. The sections of the side walls 12 that correspond to the plate member 20 are such that one of the opposing end sides in the width direction X is open, which enables the plate member 20 to be inserted from the open end side.

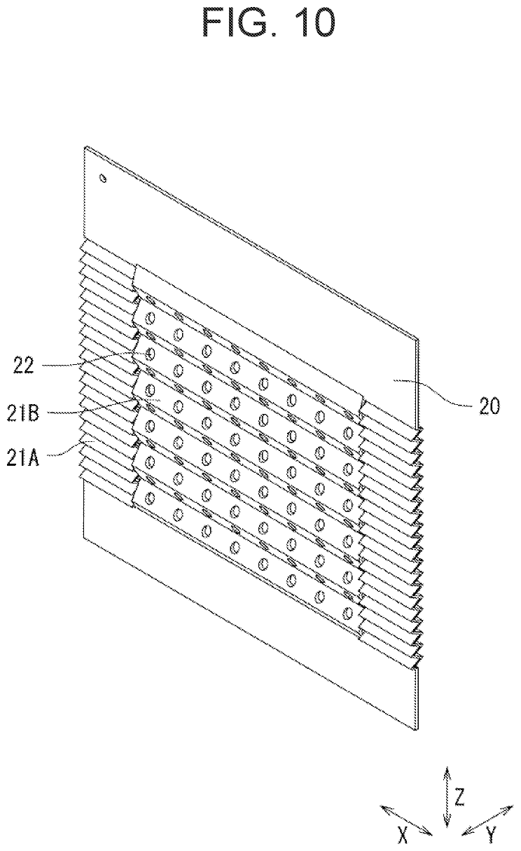

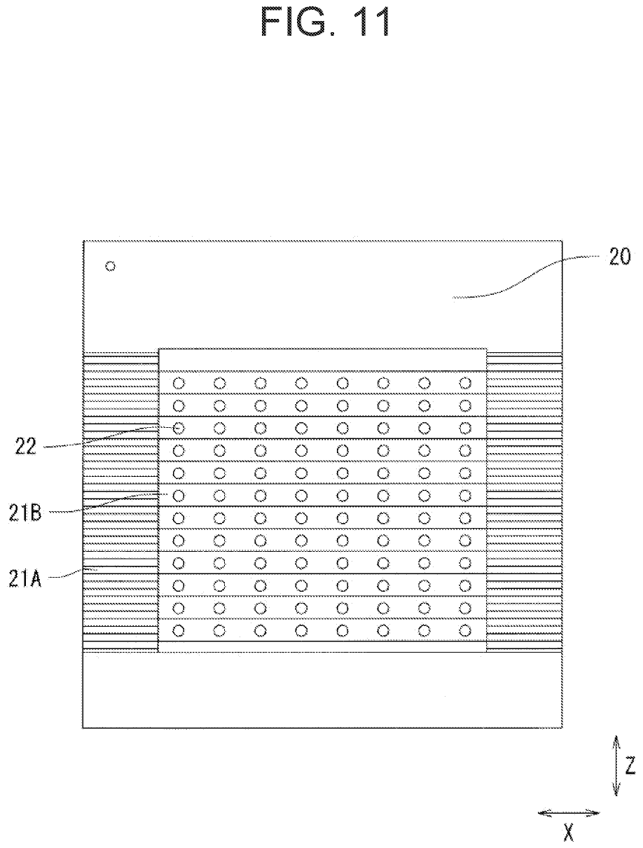

FIG. 10 is a perspective view of a plate member. FIG. 11 is a front view of a plate member.

The plate member 20 is provided with a contacter that makes contact with the metal-air battery cell 30. The contacter is provided with a first contact region, and second contact regions having a higher contact density than the first contact region. The first contact region is provided in a position facing the opening. The second contact regions are provided in positions facing the water-repellent film welded part. In the present embodiment, the contacter is formed in a corrugated plate shape. In order to distinguish from a second embodiment and a third embodiment described below, hereinafter, the first contact region will be referred to as a coarsely corrugated part 21B, and the second contact regions will be referred to as densely corrugated parts 21A.

The upper end and the lower end of the plate member 20, which is supported by the fixing member 10, are formed flat, and the central portion in the height direction Z serves as the contacter. The channels provided in the contacter are formed with an orientation parallel to the flow path of air along the width direction X. In this way, because air flows through the channels provided in the contacter, air can be efficiently taken into the metal-air battery cell 30.

The coarsely corrugated part 21B has a corrugated shape which is bent so that the spacing between the channels is wide. Further, the densely corrugated part 21A have a corrugated shape which is bent so that the spacing between the channels is narrower than the coarsely corrugated part 21B. In this way, the contact density of the coarsely corrugated part 21B and the densely corrugated parts 21A is different due to a difference provided in the spacing between the channels. Specifically, in the coarsely corrugated part 21B, the spacing between protrusions that protrude on the same side is preferably 5 mm to 15 mm, and more preferably 7 mm to 9 mm. The densely corrugated parts 21A are configured to be approximately twice as dense as the coarsely corrugated part 21B, and the spacing between protrusions is preferably 2.5 mm to 5 mm. In the coarsely corrugated part 21B and the densely corrugated parts 21A, the corners of the corrugations may be rounded into a smooth shape. As a result, the surface of the metal-air battery cell 30 that is making contact, including the water-repellent film 37, can be prevented from becoming scratched.

In the water-repellent film welded part 312, in which different members are welded together, detachment may occur due to expansion deformation. A detachment between the water-repellent film 37 and the resin film 31 causes the electrolyte to leak out from the detached portion, which impedes the passage of air. Therefore, even when the metal-air battery cell 30 itself expands, it is necessary to hold the water-repellent film welded part 312 in place so as to prevent deformation as much as possible. In the present embodiment, when the metal-air battery cell 30 and the plate member 20 are fixed by the fixing member 10, in the metal-air battery cell 30, the fixing member 10 makes contact with the water-repellent film welded part 312 at the upper end and the lower end, and the densely corrugated parts 21A make contact with the water-repellent film welded part 312 at the side ends (the left and right sides in FIG. 2). In addition, when the surface of the metal-air battery cell 30 (specifically, the inside of the opening 311) is blocked, the flow of air will be impeded. Therefore, by providing a difference in the contact density in the contacter, the flow path of air can be ensured by suppressing the expansion of the metal-air battery cell 30, while also assisting the intake of air into the metal-air battery cell 30.

The coarsely corrugated part 21B is provided with through holes 22 that penetrate the plate member 20 in the thickness direction Y. In this way, by providing the through holes 22, air flows through the through holes 22 which further promotes the supply of air. Furthermore, when the temperature of the metal-air battery cells 30 rises due to battery operation, the air between the metal-air battery cells 30 generates a rising air current via the through holes 22. The upward air flow escapes from both upper ends of the plate members 20, and at the same time air flows in from both lower ends of the plate members 20 due to a chimney effect. In the present embodiment, the diameter (φ) of the through holes 22 is 1.0 mm to 2.0 mm. The diameter and number of through holes 22 may be appropriately designed in consideration of the strength of the plate members 20 themselves.

As shown in FIG. 1 to FIG. 3, by fixing the metal-air battery cells 30 and the plate members 20 with the fixing member 10, it is possible to suppress the deformation of the metal-air battery cells 30 while also ensuring an air supply.

As described above, by providing a difference in the contact density in the contacter, the flow path of air can be ensured by suppressing the expansion of the metal-air battery cells 30, while also assisting the intake of air into the metal-air battery cells 30.

In the metal-air battery cells 30, the contents tend to accumulate and expand in the lower part due to the weight of the contents. However, because the plate members 20 are arranged so as to stand along the surfaces of the metal-air battery cells 30, a configuration is possible in which the plate members 20 readily make contact with the lower part of the metal-air battery cells 30, and the plate members 20 do not readily make contact with the upper part of the metal-air battery cells 30. This allows the expansion of the metal-air battery cell 30 to escape in an upward direction, while ensuring the flow path of air.

### Second Embodiment

Next, a metal-air battery module according to a second embodiment of the present disclosure will be described below with reference to the drawings.

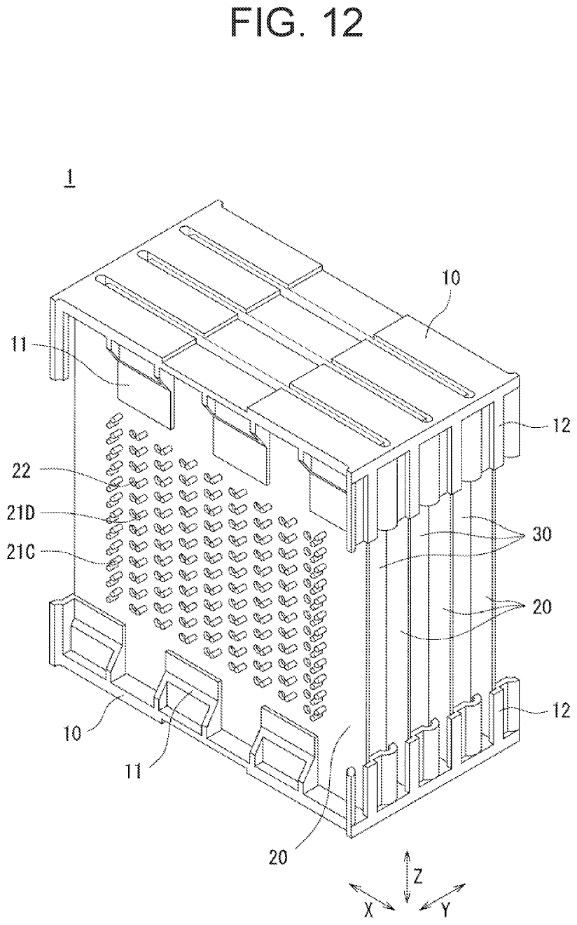

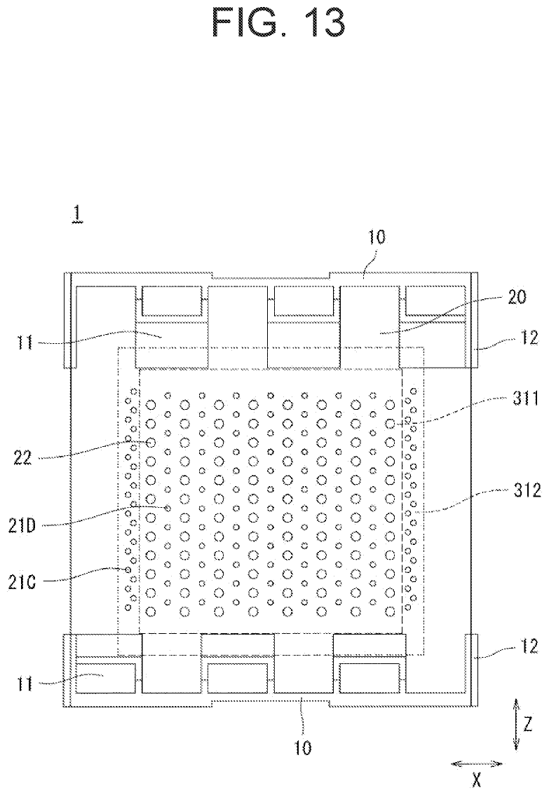

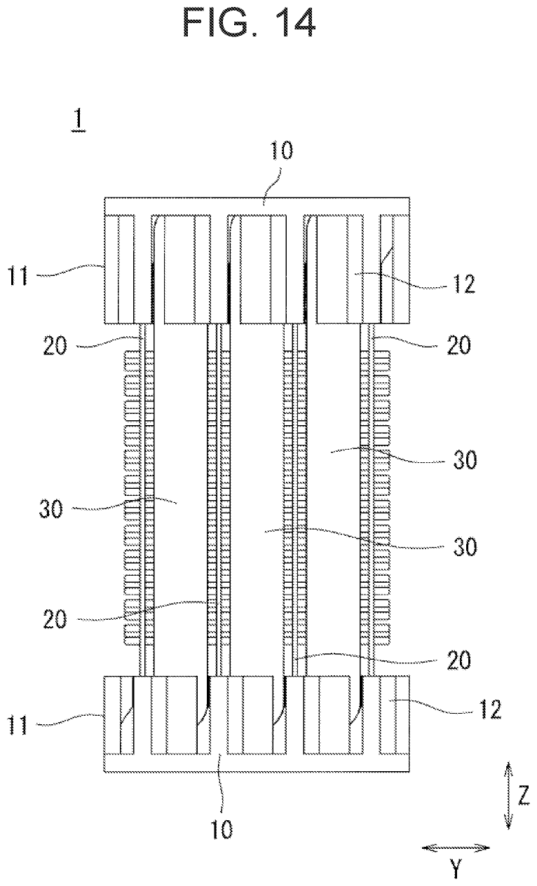

FIG. 12 is a perspective view of the metal-air battery module according to the second embodiment of the present disclosure. FIG. 13 is a front view of the metal-air battery module according to the second embodiment of the present disclosure. FIG. 14 is a side view of the metal-air battery module according to the second embodiment of the present disclosure. In FIG. 13, a portion of the metal-air battery cell 30 is shown transparently for ease of viewing of the diagram.

In the second embodiment, the shape of the plate member 20 is different to that of the first embodiment. It should be noted that the second embodiment has substantially the same configuration as the first embodiment illustrated in FIG. 1 to FIG. 11. Therefore, the description of the metal-air battery cell 30 and the fixing member 10 will be omitted, and the plate member 20 will be described.

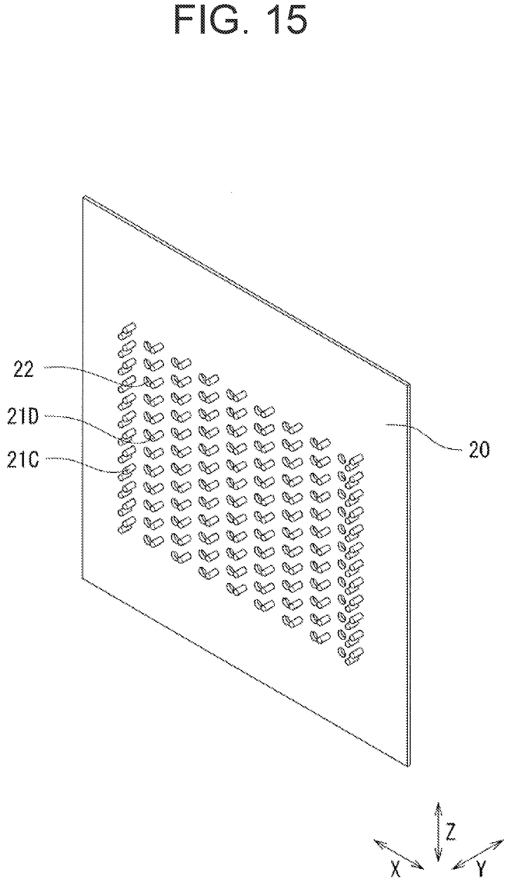

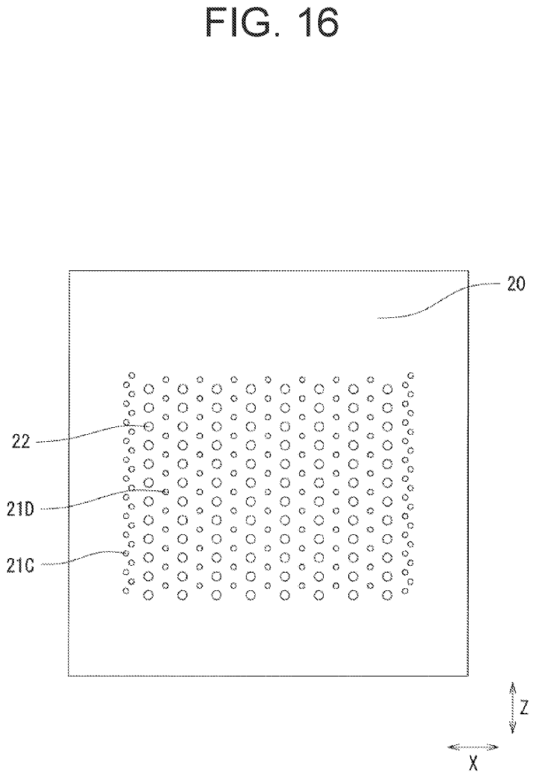

FIG. 15 is a perspective view of a plate member. FIG. 16 is a front view of a plate member.

The plate member 20 has a contacter that makes contact with the metal-air battery cell 30. In the present embodiment, the contacter is made of cylindrical protrusions. That is, in the present embodiment, the plate member 20 is a flat plate, and protrusions are provided at locations corresponding to the contacter. In the present embodiment, the protrusions corresponding to the first contact region are referred to as first cylindrical protrusions 21D, and the protrusions corresponding to the second contact region are referred to as second cylindrical protrusions 21C.

The upper end and the lower end of the plate member 20, which is supported by the fixing member 10, is not provided with the contacter, and the central portion in the height direction Z is provided with the contacter. The first cylindrical protrusions 21D and the second cylindrical protrusions 21C preferably have a diameter (φ) of 0.8 mm to 1.2 mm. In the present embodiment, the diameter (φ) is set to 1.0 mm. The height that the first cylindrical protrusions 21D and the second cylindrical protrusions 21C protrude may be appropriately set according to the spacing of the metal-air battery cells 30. Furthermore, the ends of the first cylindrical protrusions 21D and the second cylindrical protrusions 21C may be spherically processed, or the corners may be rounded and made smooth, such that the water-repellent film 37 or the like that is making contact is prevented from being scratched.

The first cylindrical protrusions 21D are arranged side-by-side with a spacing of 5 mm to 15 mm in the width direction X and the height direction Z. The second cylindrical protrusions 21C are arranged in a staggered pattern with a spacing of 2.5 mm along the height direction Z. The present disclosure is not limited to this. The number of second cylindrical protrusions 21C that are provided may be adjusted according to the size of the second contact region, as long as they are arranged more densely than the first cylindrical protrusions 21D. In this way, by providing a difference in the density in which the first cylindrical protrusions 21D and the second cylindrical protrusions 21C are arranged, the contact density can be made different in the contacter.

In the present embodiment, through holes 22 are provided in the first contact region. The through holes 22 are provided in positions that do not overlap with the first cylindrical protrusions 21D.

### Third Embodiment

Next, a metal-air battery module according to a third embodiment of the present disclosure will be described below with reference to the drawings.

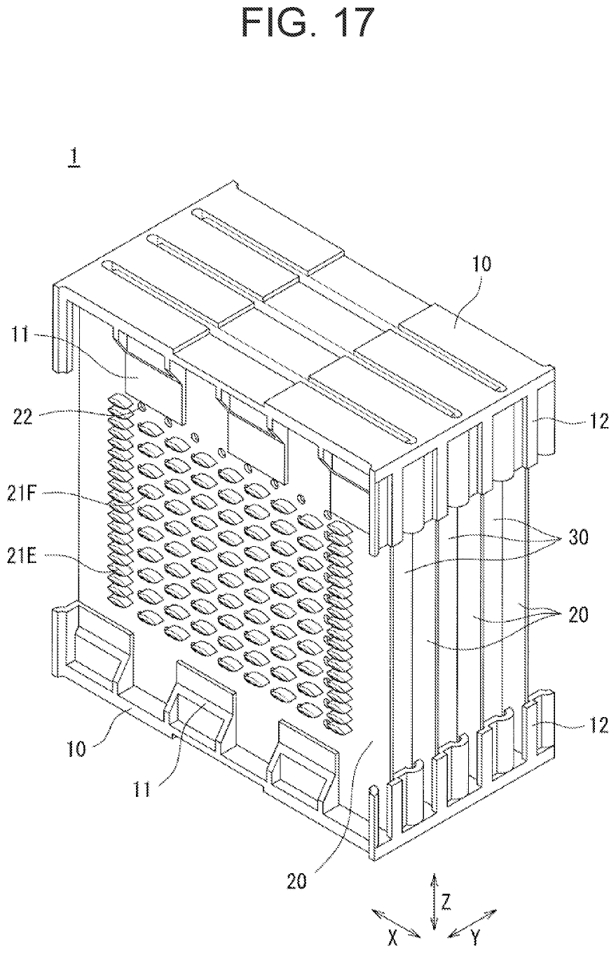

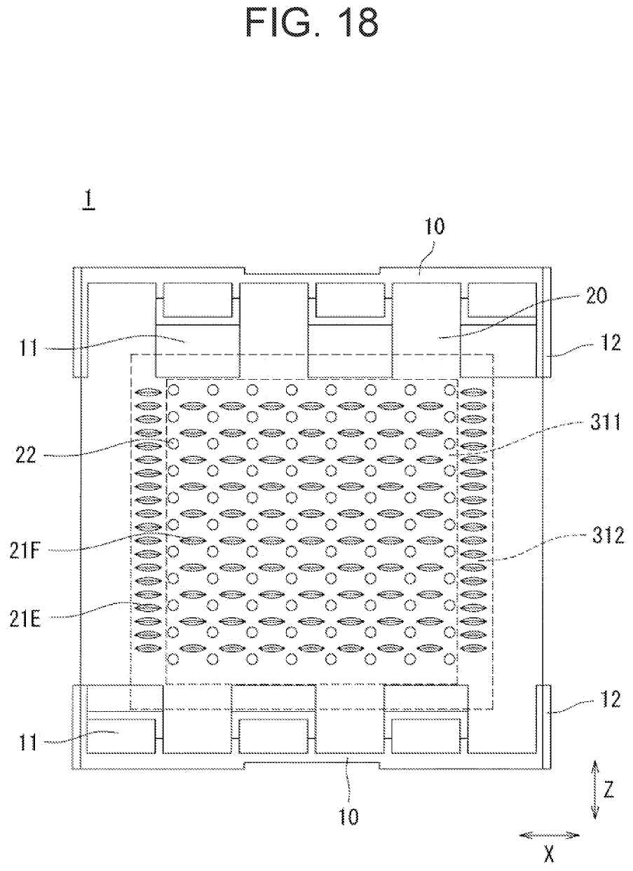

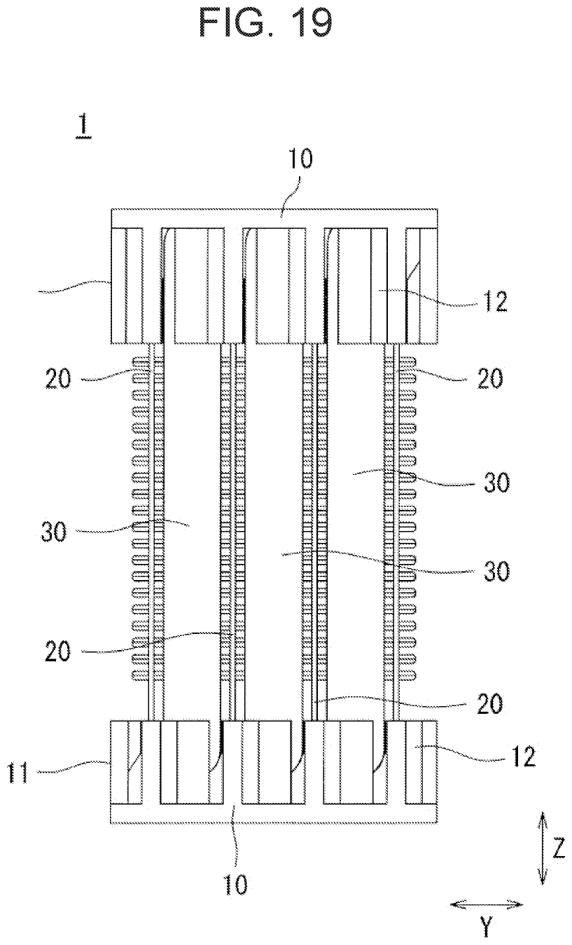

FIG. 17 is a perspective view of the metal-air battery module according to the third embodiment of the present disclosure. FIG. 18 is a front view of the metal-air battery module according to the third embodiment of the present disclosure. FIG. 19 is a side view of the metal-air battery module according to the third embodiment of the present disclosure. In FIG. 18, a portion of the metal-air battery cell 30 is shown transparently for ease of viewing of the diagram.

In the third embodiment, the shape of the plate member 20 is different to that of the first embodiment. It should be noted that the third embodiment has substantially the same configuration as the first and second embodiments illustrated in FIG. 1 to FIG. 16. Therefore, the description of the metal-air battery cell 30 and the fixing member 10 will be omitted, and the plate member 20 will be described.

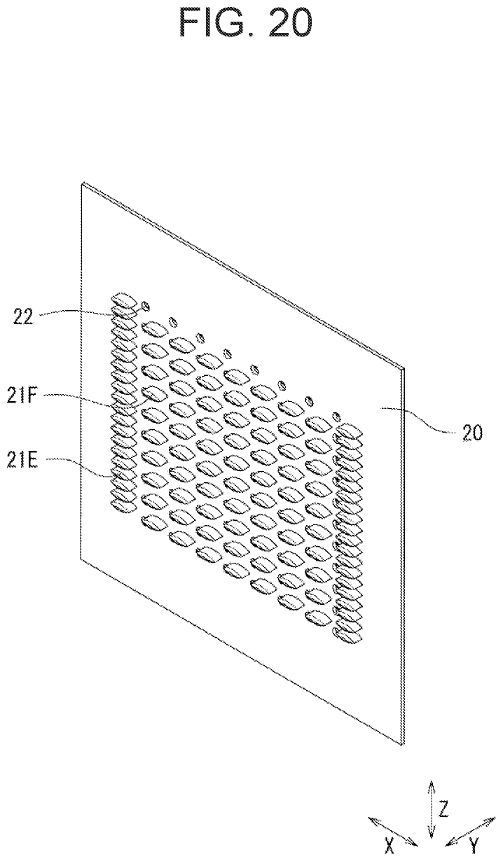

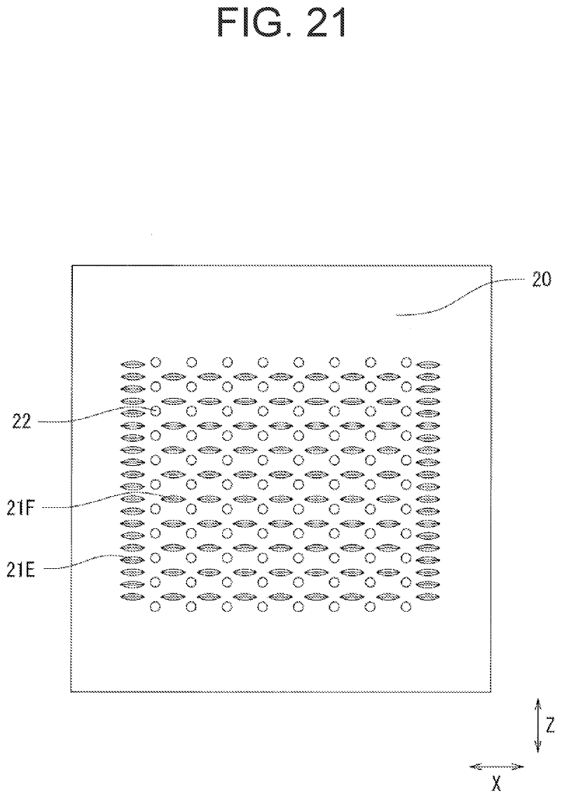

FIG. 20 is a perspective view of a plate member. FIG. 21 is a front view of a plate member.

The plate member 20 has a contacter that makes contact with the metal-air battery cell 30. In the present embodiment, the contacter is made of spindle-shaped protrusions. That is, in the third embodiment, the shape of the protrusions provided on the plate member 20 is different to that of the second embodiment. In the present embodiment, the protrusions corresponding to the first contact region are referred to as first spindle protrusions 21F, and the protrusions corresponding to the second contact region are referred to as second spindle protrusions 21E.

The upper end and the lower end of the plate member 20, which is supported by the fixing member 10, is not provided with the contacter, and the central portion in the height direction Z is provided with the contacter. The first spindle protrusions 21F and the second spindle protrusions 21E are formed wide in the width direction X, and preferably have a length of 5 mm to 15 mm. The height that the first spindle protrusions 21F and the second spindle protrusions 21E protrude may be appropriately set according to the spacing of the metal-air battery cells 30. Furthermore, the ends of the first spindle protrusions 21F and the second spindle protrusions 21E may be spherically processed, or the corners may be rounded and made smooth, such that the water-repellent film 37 or the like that is making contact is prevented from being scratched.

The first spindle protrusions 21F are arranged side-by-side with a spacing of 5 mm to 15 mm in the width direction X and the height direction Z. The second spindle protrusions 21E are arranged side-by-side in single rows with a spacing of 2.5 mm along the height direction Z. The present disclosure is not limited to this. The number of second spindle protrusions 21E that are provided may be adjusted according to the size of the second contact region, as long as they are arranged more densely than the first spindle protrusions 21F. In this way, by providing a difference in the density in which the first spindle protrusions 21F and the second spindle protrusions 21E are arranged, the contact density can be made different in the contacter.

In the present embodiment, because the protrusions have a wide spindle shape, the mechanical strength increases compared to protrusions having a cylindrical shape. Furthermore, because the cross-sectional area in the height direction Z becomes smaller than in the width direction X, the flow resistance with respect to air can be reduced. In addition, the first spindle protrusions 21F are arranged side-by-side such that the spacing is greater in the height direction Z than in the width direction X. As a result of the spacing in the height direction Z being greater, obstruction of the flow path of air can be prevented, which enables air to be efficiently taken into the metal-air battery cell 30.

In the present embodiment, through holes 22 are provided in the first contact region. The through holes 22 are provided in positions that do not overlap with the first spindle protrusions 21F.

The embodiments disclosed herein are illustrative in all respects and are not intended to be the basis for a limiting interpretation. The technical scope of the present disclosure is not intended to be understood based only on the embodiments described above, and is intended to be defined by the following claims. All modifications within the meaning and the scope e equivalent to the claims fall within the scope of the present disclosure.

What is claimed is:

1. A metal-air battery module comprising:
a metal-air battery cell;
a plate member; and
a pair of fixing members; wherein
the metal-air battery cell has a film-like packaging material provided with an opening, and a water-repellent film which is arranged and welded so as to cover the opening,
the plate member is arranged facing a surface of the metal-air battery cell, the surface being provided with the opening, and
the metal-air battery cell and the plate member are fixed by the pair of fixing members at a surface end in a surface direction, which is a direction along a surface in which the metal-air battery cell and the plate member face each other, the pair of fixing members being opposingly arranged so as to sandwich both components in the surface direction.

2. The metal-air battery module according to claim 1, wherein
the plate member is provided with a contacter that makes contact with the metal-air battery cell, and
the contacter is provided with a first contact region, and a second contact region having a higher contact density than the first contact region.

3. The metal-air battery module according to claim 2, wherein
the metal-air battery cell is provided with a water-repellent film welded part along a circumferential edge of the opening, on which the water-repellent film is welded,
the first contact region is provided in a position facing the opening, and
the second contact region is provided in a position facing the water-repellent film welded part.

4. The metal-air battery module according to claim 3, wherein
a portion of the pair of fixing members is provided in a position facing the water-repellent film welded part.

5. The metal-air battery module according to claim 2, wherein
the contacter is formed in a corrugated plate shape.

6. The metal-air battery module according to claim 5, wherein
a channel provided in the contacter is formed with an orientation parallel to a flow path of air.

7. The metal-air battery module according to claim 2, wherein
the contacter is a cylindrical protrusion.

8. The metal-air battery module according to claim 2, wherein
the contacter is a spindle-shaped protrusion.

9. The metal-air battery module according to claim 1, wherein
the pair of fixing members hold ends of the plate member, and fix positions thereof.

10. The metal-air battery module according to claim 1, wherein
the plate member is provided with a through hole that penetrates therethrough.
